(19) United States
(12) Patent Application Publication
(10) Pub. No.: US 2022/0188403 A1
(43) Pub. Date: Jun. 16, 2022

(54) MULTILEVEL VIRTUAL MACHINES FOR SECURE TESTING OF PROTECTED NETWORKS

(71) Applicant: Visiotech DWC-LLC, Dubai (AE)

(72) Inventor: Montasser Moussa Mohamed Montasser, Dubai (AE)

(21) Appl. No.: 17/120,819

(22) Filed: Dec. 14, 2020

(51) Int. Cl. G06F 21/53; G06F 21/54; G06F 21/55; G06F 21/56; G06F 21/62; G06F 9/455

(52) U.S. Cl. CPC G06F 21/53; G06F 21/54; G06F 21/554; G06F 2009/45587; G06F 21/6218; G06F 9/45558; G06F 2009/45595; G06F 21/564

(57) ABSTRACT

Secure services for a protected computer network are provided using a multi-leveled virtual machine. A test computer network and the protected computer network are in network communication with each other. A test computer on the test computer network runs a first virtual machine (VM) on which the secure services are run. A second VM running on the first VM emulates a target protected network computer. When a predetermined test event occurs, the first and second VMs are automatically isolated in a secure test bubble to perform secure services using the second virtual machine. The secure test bubble can be used to (1) test software updates and patches for the PN computers, (2) download files from the PN computers, and (3) perform maintenance tasks on the PN computers. After the secure services are performed, the first and second VMs are destroyed to eliminate any threats to the protected network.

### TECHNICAL FIELD

This application relates generally to improved security for protected computer networks.

### BACKGROUND

Computer networks are vulnerable to external threats. Even air-gapped networks can be exposed to threats during maintenance or upgrades through the use of external storage devices. Most Industrial control systems, such as SCADA in Oil & Gas facilities or Energy Generation Plants, require higher security measures than those used within ordinary networks.

It would be desirable to improve the security of networks with such high security needs.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a system comprising a protected network and a test network in network communication with the protected network. The protected network comprises a protected network server having a physical microprocessor; and a plurality of protected network computers in network communication with the protected network server, each protected network computer having a physical microprocessor. The test network comprises a test network server having a physical microprocessor; and a test network computer having a physical microprocessor, the test network computer in network communication with the test network server. The test network computer runs a first virtual machine that monitors the test network computer and/or the first virtual machine for a predetermined test event. The first virtual machine runs a second virtual machine that emulates a first protected network computer. The test network server runs a virtual server that is in virtual network communication with the first and second virtual machines. When the predetermined test event occurs, the first and second virtual machines are automatically disconnected from the virtual server, the test network server, and the protected network to isolate the first and second virtual machines in a secure test bubble.

In one or more embodiments, the predetermined test event comprises a connection of an external memory device to the test network computer. In one or more embodiments, the external memory device comprises a USB flash drive. In one or more embodiments, the external memory device includes one or more files stored thereon, the one or more files corresponding to changes to the first protected network computer.

In one or more embodiments, the predetermined test event comprises a user input on the test network computer and/or on the first virtual machine. In one or more embodiments, the first virtual machine is configured to automatically restart in response to a signal that indicates that a user has completed a secure service on the second virtual machine, thereby deleting both the first and second virtual machines.

In one or more embodiments, the virtual server is configured to convert each protected network computer into second virtual machine files (e.g., virtual machine disk VMDK format) that are readable by the first virtual machine to run the second virtual machine. In one or more embodiments, the virtual server is configured to monitor for changes to each protected network computer and to update the second virtual machine files (e.g., virtual machine disk VMDK format) accordingly. In one or more embodiments, the second virtual machine is configured to have access to a local copy of a network-accessible shared folder, the local copy comprising one or more files that correspond to downloadable files for the first protected network computer.

Another aspect of the invention is directed to a method comprising establishing a first network connection between a test network server and a protected network, the protected network including a protected network server and a plurality of protected network computers, the protected network server and the protected network computers in network communication with each other; establishing a second network connection between the test network server and a plurality of test network computers; running a first virtual machine on a first test network computer; running a virtual server on the test network server, the virtual server configured to convert each protected network computer into second virtual machine files, the second virtual machine files (e.g., virtual machine disk VMDK format) readable by the first virtual machine; running a second virtual machine on the first virtual machine using the second virtual machine files (e.g., virtual machine disk VMDK format) for a specific protected network computer; establishing a virtual network connection between (a) the first virtual machine and the second virtual machine and (b) and the virtual server; monitoring, with the first virtual machine, the test network computer and/or the first virtual machine for a predetermined test event; and when the predetermined test event occurs: automatically disabling the virtual network connection to isolate the first and second virtual machines from the virtual server, the test network server, and the protected network in a secure test bubble, and performing a secure service with the second virtual machine while the first and second virtual machines are in the secure test bubble.

In one or more embodiments, the predetermined test event comprises connecting an external memory device to the first test network computer. In one or more embodiments, the external memory device comprises a USB flash drive. In one or more embodiments, the external memory device includes one or more files stored thereon, the one or more files corresponding to the changes to the first protected network computer.

In one or more embodiments, the predetermined test event comprises a user input on the first test network computer and/or on the first virtual machine. In one or more embodiments, the method further comprises automatically deleting the first and second virtual machines in response to a signal that indicates that a user has completed the secure service in the secure test bubble. In one or more embodiments, the virtual server is configured to monitor for changes to each protected network computer and to update the second virtual machine files (e.g., virtual machine disk VMDK format) accordingly. In one or more embodiments, the second virtual machine is configured to have access to a local copy of a network-accessible shared folder, the local copy comprising one or more files that correspond to downloadable file(s) for the first protected network computer.

In one or more embodiments, the method further comprises using the first virtual machine to determine whether a software change is safe to install on the first protected network computer; and when the first virtual machine determines that the software change is safe to install, the method further includes: saving files corresponding to the software changes to a shared folder on the test network server; synchronizing the shared folder on the test network server with a shared folder on the protected network server to copy the files from the test network server to the protected network server; and copying the files from the shared folder on the protected network server to the first protected network computer. In one or more embodiments, the method further comprises running an antivirus application on the first virtual machine to determine whether the software change includes a virus or a malware.

In one or more embodiments, the method further comprises using the first virtual machine to determine whether a software change is safe to install on the first protected network computer; and when the first virtual machine determines that the software change is safe to install, the method further includes: saving a modified image of the first protected network computer to a shared folder on the test network server, wherein the software change comprises a maintenance activity for the first protected network computer; saving the modified image from the shared folder on the test network server to a shared folder on the protected network server; and cloning the modified image to the first protected network computer from the shared folder on the protected network server.

Those skilled in the art will understand that the second virtual machine or VMDK disk format is an example format and other formats may be substituted without loss of generality within the scope of the present disclosure and claims.

In one or more embodiments, the secure service comprises downloading a file from the second virtual machine to an external memory device.

### BRIEF DESCRIPTION OF THE DRAWINGS

Fora fuller understanding of the nature and advantages of the present concepts, reference is made to the following detailed description of preferred embodiments in connection with the accompanying drawings.

FIG. 1 is a block diagram of a system in a first state (e.g., an “off” state) for securing a protected network against threats.

FIG. 2 is a block diagram of the system illustrated in FIG. 1 in a second state (e.g., an “on” state).

FIG. 3 is a block diagram of the system illustrated in FIG. 1 in a third state (e.g., an “active” state).

FIG. 4 is a block diagram of a secure test bubble, when the system illustrated in FIG. 1 is in fourth state (e.g., a “bubble” state).

FIG. 5 is a flow chart of a method for secure testing of operating system or application changes after updates are applied using files from an external media, according to an embodiment.

FIG. 6 is a flow chart of a method for downloading files stored on a network-accessible folder to an external movable media device while securing protected network according to an embodiment.

FIG. 7 is a flow chart of a method for secure maintenance of a computer in a protected network according to an embodiment.

FIG. 8 is a block diagram that illustrates a second virtual machine that emulates a target physical computer in the protected network.

FIG. 9 is a flow chart of a method for securely testing changes to a protected network computer according to an embodiment.

### DETAILED DESCRIPTION

Secure services for a protected computer network are provided using a multi-leveled virtual machine that is run on a test computer network. The test computer network includes one or more test servers that is/are in network communication with one or more test computers. The protected computer network includes one or more protected network servers that is/are in network communication with a plurality of protected network computers. The protected computer network and the test computer network are in network communication with each other.

At least one of the test servers runs a virtual server that is in virtual network communication with a first virtual computer running on a first test computer. Additional virtual computers can run on additional test computers. The virtual server includes software that converts each protected network computer into a format (e.g., as second virtual machine files such as Virtual Machine Disk or VMDK format without limitation) that is readable by other software installed on first virtual machines. A user can then use software running on the first virtual machine to select and run a second virtual machine that corresponds to (e.g., exactly emulates) a given protected network computer, on the first virtual machine. After the second virtual machine is running, the user can perform a predetermined action and/or command, such as inserting a USB flash drive into a physical port on the first test computer that is only logically connected to the first and second virtual machines, to initiate a secure service platform. When the predetermined action and/or command occurs, the first and second virtual machines are disconnected and isolated from the virtual server, the test server(s), and the protected computer network to form a secure test bubble which provides a secure environment. The secure environment can be used to determine whether any potential changes (e.g., operating system changes, software updates, etc.) to the selected protected network computer(s) are threatening or harmful (e.g., include viruses, malware, and/or other undesirable features) prior to installation on protected network computer(s), to securely download files from the selected protected network computer, and/or to securely operate the selected protected network computer(s) during a crisis. When the secure services are terminated, the entire test bubble is deleted or destroyed, including the first and second virtual machines. Any changes to the first and second virtual machines, such as any threatening or harmful features contained therein as a result of using the secure services, are also destroyed and/or deleted, and thus cannot propagate to the rest of the test computer network or to the protected computer network.

In an aspect, VX Solution in its default configuration has two hardware servers on which virtualization software (for this example VMware vSphere®) is used as data center management server for managing VMware ESXi enterprise-class, type-1 hypervisor, installed on both physical servers, ESX-1 & ESX-2, as well as managing the multiple virtual machines created and used for the different processes described after.

One or more workstation(s) using an operating system such as LINUX®, will have a special VX script that calls VirtualBox, used to emulate the standard virtual machine VX1. This VX1 has VX software that runs the services detailed herein including a web browser, antivirus software, and the required GUI for a user-friendly interaction.

This very same VM VX1, will be turned on, on each additional physical workstation offering VX Solution services to users. As many as required can be added to VX Network providing hardware capacity limits are maintained.

The web browser, which is on by default, on the first virtual machine is used as the primary interface to call and run VX software functions including calling the required second virtual machines VMs from ESXi as needed. VX software on ESX1 uses the VMware converter utility to convert all protected workstations on the protected network (PN) into second virtual machine files (e.g., virtual machine disk VMDK format) to be kept on a “Protected Virtual Machines Pool.” The second virtual machine files (e.g., virtual machine disk VMDK format) can represent an image of each PN workstation (e.g., including the operating system and any software loaded on the protected workstation). VX will monitor all PN workstations periodically for any registry files' changes. If such is detected, new second virtual machine files (e.g., a new or updated virtual machine disk VMDK format) overwrites the old one. However, the update can be processed at a time selected with the least traffic on PN network based on historical traffic data.

The Front Virtual Station VM VX1 (e.g., the first virtual machine), loaded by default on start-up, with its default web service launching the main GUI, will prompt the user for selecting the required service. The user, who should not necessarily be a professional system/network administrator, will choose from VX default menu, the required service. This menu includes: (1) testing platform for upload purposes, (2) maintenance platform, (3) download service, and (4) crisis management.

The whole process is VX solution led, using a sequence of procedures that allow the user the flexibility to perform all listed services, but not a chance to harm neither VX network nor Protected network by any malicious software that could possibly be on USB flash drive used in the process. VX solution keeps protected network immune by placing all services and actions by users contained in an isolated “bubble” throughout the process. Once user requirements are done, all running contents of the “bubble” are demolished.

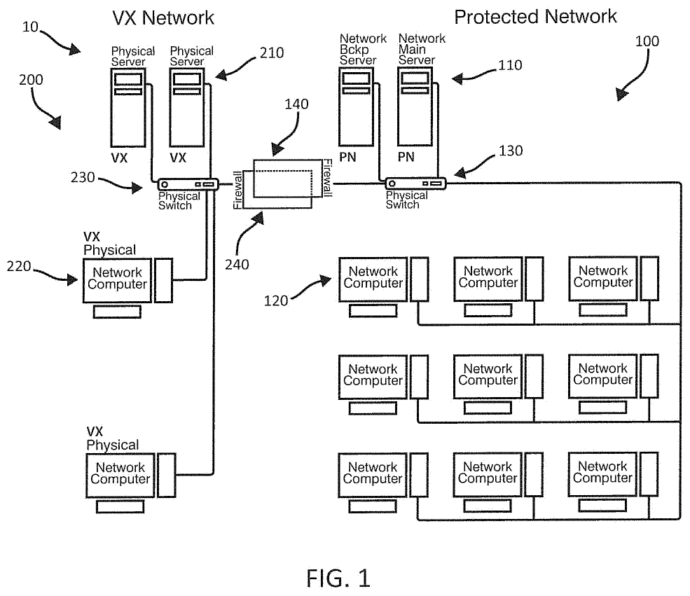

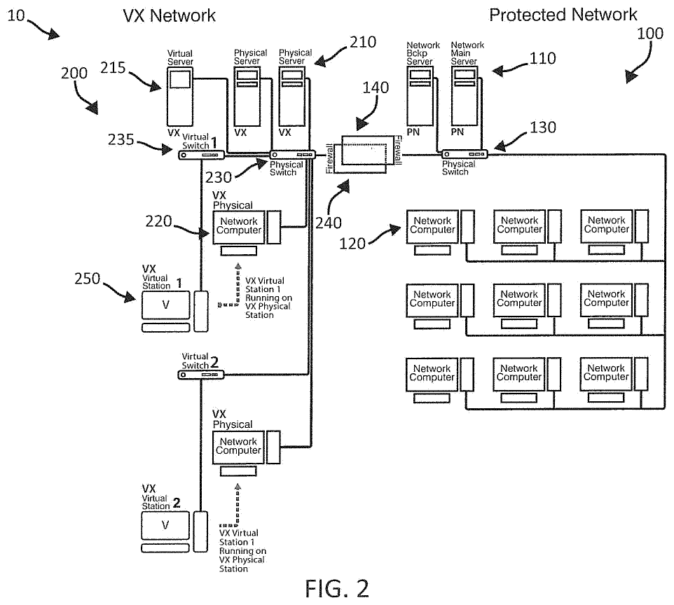

FIG. 1 is a block diagram of a system 10 for securing protected computer network. The system 10 includes a protected network 100 and a test network 200. The protected network 100 includes one or more physical servers 110 (e.g., protected network physical server(s)) that are in network communication with a plurality of physical computers 120. Though 9 physical computers 120 are illustrated in FIG. 1, there can be fewer or additional physical computers 120, such as up to 30-40 physical computers 120 in an embodiment after which additional servers and/or space may be required. The protected network 100 can be an air-gapped network, a high-security network, or other network. The physical servers and computers 110, 120 can be in network communication with each other over a wired network and/or a wireless network. The physical servers 110 can include a primary protected network server and a backup protected network server. FIG. 1 represents a first state (e.g., an “off” state) of the system 10.

The test network 200 includes one or more physical servers 210 (e.g., test physical server(s)) that are in network communication with one or a plurality of physical computers 220. The physical servers and computers 210, 220 can be in network communication with each other over a wired network and/or a wireless network. The physical servers 210 can include first and second test network servers.

Each of the physical servers 110, 210 and each of the physical computers 120, 220 includes one or more physical microprocessors, memory, and a network communication interface. In addition, the physical computers 120, 220 are coupled via ports and/or a wireless connection to a display, a user input device (e.g., a mouse, a keyboard, a microphone, and/or other user input device), a printer, external memory (e.g., a hard drive), and/or other external devices. However, certain ports (e.g., all USB ports) are disabled in the physical computers 120, 220. In some embodiments, the ports on physical computer 220 can be enabled and disabled through user interactions to on-screen commands and menus. The physical computers 120 and/or 220 can run an operating system such as Linux.

The protected network 100 and the test network 200 are in electrical communication with each other via respective physical switches 130, 230 and/or via respective firewalls 140, 240. The physical switches 130, 230 are electrically coupled to the physical servers 110, 210, respectively, and the physical computers 120, 220, respectively. Thus, the state of the physical switches 130, 230 can be changed to connect or disconnect the physical servers 110, 210, respectively, to the physical computers 120, 220. In addition, the state of the physical switches 130, 230 can be changed to connect or disconnect to/from the other network 200, 100. For example, the state of the physical switch 130 in the protected network 100 can be changed to connect or disconnect to/from the test network 200 (e.g., via the firewalls 140, 240). Likewise, the state of the physical switch 230 in the test network 200 can be changed to connect or disconnect to/from the protected network 100 (e.g., via the firewalls 240, 140).

FIG. 2 is a block diagram of the system 10 in a second state (e.g., an “on” state). The system 10 is the same as in FIG. 1 except that in FIG. 2 a virtual machine 250 is running on each physical computer 220 that is turned on. In addition, virtualization software is installed on top of the physical servers 210 to form a virtual server 215. Each virtual machine 250 is in network connection (e.g., virtual network connection) with the virtual server 215 via a virtual switch 235. The virtual switch 235 is logically disposed between the virtual machines 250 and the physical switch 230. The physical switch 230 is electrically coupled to the physical server(s) 210 on which the virtual server 215 is running. The virtual switch 235 can also run logically on the physical server(s) 210. When the virtual switch 235 and the physical switches 130, 230 are in a connected state, the virtual machines 250 are in network connection with the protected network 100 including its physical computers 120. In general, the virtual switch 235 and the physical switches 130, 230 are in a connected state when the system 10 is in the second or “on” state. The physical switches 130, 230 are connected through two simultaneously-running firewall machines 140, 240 which control, through a set of adjustable policies, the permitted type and direction of transactions between the two networks 100, 200.

The virtual server 215 can comprise server virtualization software, such as VMware vSphere® available from VMware, Inc. For example, the server virtualization software (e.g., VMware vSphere®) can be used as a data center management server for managing a VMware ESXi enterprise-class, type-1 hypervisor that is installed on first and second test network servers 210 as ESX-1 and ESX-2, respectively, as well as for managing the multiple virtual machines 250 created and used as described herein. The server virtualization software can convert each physical computer 120 in the protected network 100 to a format (e.g., as second virtual machine files) that is readable by the virtual machines 250, such as VMDK files. VDMK is a file format that describes containers used in virtual machines like VMware Workstation and VirtualBox®. An example of the server virtualization software that can perform this conversion is the VMware Converter utility. Software running on the virtual server 215 can monitor the protected network physical computers 120 for any changes, such as for any changes to the files (e.g., registry files) for any of the physical computers 120 or any other physical computer of the protected network 100. When any such change occurs, the software running on the virtual server 215 can update and/or overwrite the second virtual machine files (e.g., virtual machine disk VMDK format) of the corresponding physical computer 120 that are readable by the virtual machines 250. Again, the exemplary VMDK and similar formats are not limiting but may be equivalently substituted by file or virtual machine formats as deemed appropriate for a given implementation. In some embodiments, a time with lower or reduced traffic on protected network 100 can be selected, based on historical traffic data, to process such an update.

The virtual machine 250 can comprise a general-purpose virtual machine. For example, the virtual machine 250 can include the VirtualBox® virtual machine for x86 virtualization, available from Sun Microsystems, Inc., which can be used to emulate a Standard Virtual Machine. The virtual machine 250 can include services such as a web browser, antivirus software, and a graphical user interface (GUI) for user-friendly interaction. The web browser can be used as the primary interface to call and run VX software functions including calling or requesting additional virtual machines from the virtual server 215 as needed. Alternatively, the GUI software can comprise a dedicated application that runs on the first virtual machine 250.

In some embodiments, the web browser provides a main GUI that can prompt the user for selecting one of many secure services, such as (1) a secure testing platform for upload purposes, (2) a secure maintenance platform, (3) a secure download service, or (4) crisis management. The test services use certain procedures that prevent any harm to the protected network 100 and to the test network 200 by any malicious software that could possibly be included with files transferred during the testing process. During testing, the virtual machine 250 used for testing, including all services and actions by the user of the virtual machine 250, is isolated from the protected network 100 and the test network 200 in an isolated secure “test bubble.” Once testing is complete, all running contents of the “test bubble” are demolished.

In one example, the secure service is used as a secure testing platform for upload purposes. The secure testing platform for upload purposes can be used to (a) test an update of a current operating system on one or more specific physical computers 120 within the protected network 100, (b) test a patch of a current operating system on one or more specific physical computers 120 within the protected network 100, or (c) test an update of the current antivirus/antimalware program(s) installed on one or more specific physical computers 120 within the protected network 100.

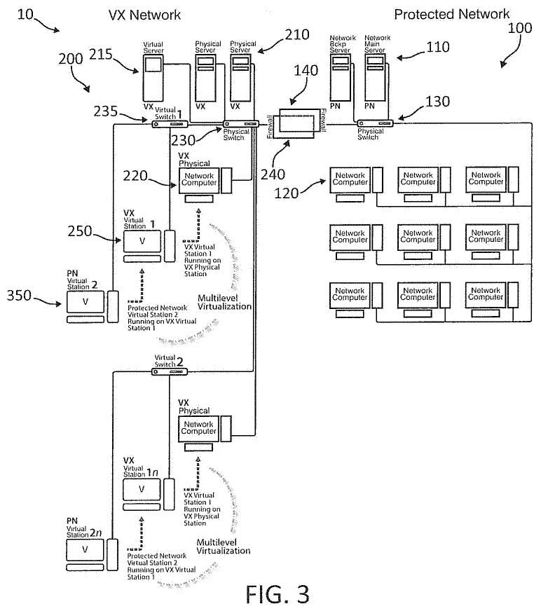

After the “secure testing platform for upload purposes” option is selected in the web browser of the virtual machine 250, a second virtual machine 350 is loaded on the virtual machine 250, as illustrated in FIG. 3 which illustrates a third state (e.g., an “active” state) of the system 10. The second virtual machine 350 emulates (e.g., exactly emulates) one of the physical computers 120, particularly the required physical computer 120 for testing. Thus, the second virtual machine 350 can be used to securely test the new patch/update (e.g., of the operating system and/or antivirus/antimalware program(s)) on a specific physical computer 120. The first and second virtual machines 250, 350 are an example of a multi-leveled virtual machine. One advantage of a multi-leveled virtual machine include that the first virtual machine 250 is not exposed to any untested files which could compromise the testing interface. Another advantage of a multi-leveled virtual machine is that the second virtual machine 350 is exposed to untested files in an isolated manner and can be demolished or deleted without impacting any other process. Also, if the first and second virtual machines 250, 350 were combined, then there would no longer be a virtual machine that exactly emulates a target physical computer 120 since the combined virtual machine would include testing software that is not installed on the target physical computer 120.

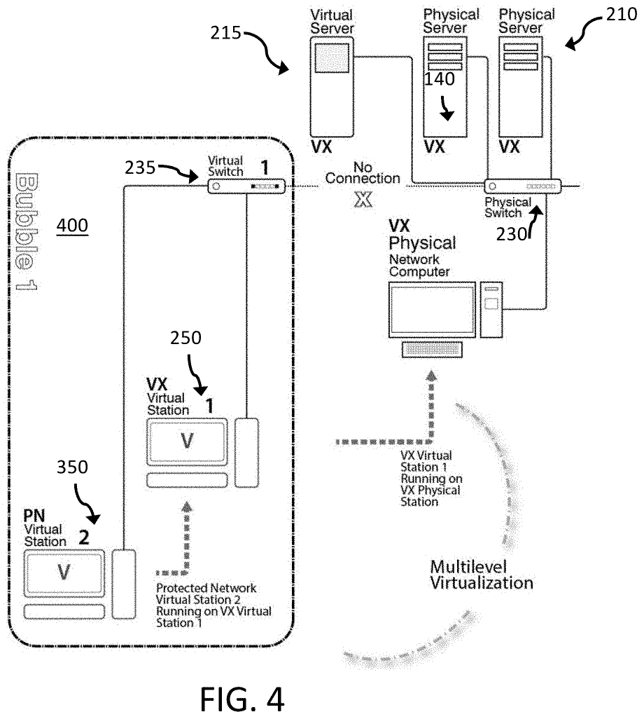

The new patch/update can be saved on a USB flash drive, which can be inserted into a USB port of the test physical computer 220 on which the first and second virtual machines 250, 350 are running. By default, all USB ports of the physical computers 120, 220 on the test and protected networks 100, 200 are disabled. Once the USB flash drive containing the new patch/update is inserted to a USB port of the test physical computer 220 on which the first and second virtual machines 250, 350 are running, the first and second virtual machines 250, 350 are automatically disconnected from all other physical and virtual computers and all physical and virtual servers, as illustrated in FIG. 4, to form a secure test bubble 400. In some embodiments, “USB over Ethernet” technology can be used to create a virtual USB port on the second virtual machine 250. Thus when a user is prompted to insert a USB drive into a physical station 220 hardware port, the user is logically inserting the USB drive into a virtual USB port on the second virtual machine 250. During this process, no logical connection is established with the physical machine 220 or any software running thereon.

The secure test bubble 400 is formed automatically in response to a predetermined test event on the test physical computer 220 that is logically transferred to the first virtual machine 250. The test event can include the connection of an external memory device (e.g., external hard drive, USB flash drive, CD (e.g., in an internal or external CD drive), DVD (e.g., in an internal or external DVD drive), smartphone, or other external memory device) to a test physical computer 220, such as insertion of a USB flash drive into a USB port of the test physical computer 220, a user command on the test physical computer 220 and/or on the first virtual machine 250, a user input on the test physical computer 220 and/or on the first virtual machine 250, or other predetermined test event.

The secure test bubble 400 can be formed by (1) using a combination of physical and virtual switches (e.g., physical switch 230 and virtual switch 235) with the physical server(s) 210, and/or (2) using two virtual firewalls, creating a demilitarized zone (DMZ) configured to perform the “test bubble” effect through adequate policies. The choice of which technique to form the secure test bubble 400 depends on the requirements of the protected network 100. After the secure test bubble 400 is formed, the new patch/update can be loaded onto the second virtual machine 350 for secure testing in the isolated environment provided by the secure test bubble 400. After the new patch/update is tested, the first virtual machine 250 and its contents, and the second virtual machine 350 and its contents, including the new patch/update, and the virtual switch 235 are destroyed.

In another example, the secure service on virtual machine 250 is used as a secure maintenance platform where authorized administrators can perform required operating system updates, patch installations, or perform required antivirus/antimalware updates, and then install the modified images on specified physical computers 120 on the protected network 100. Thus, the secure maintenance platform can be used to install the patches/updates that were tested in the secure testing platform for upload purposes. This installation is performed indirectly, as discussed below, such that the virtual machines 250, 350 and the test computer 220 is not directly connected to the protected network 100.

In an embodiment, the secure maintenance platform can be launched from the web browser running on the first virtual machine 250. When the secure maintenance platform is launched, a list or diagram of the physical computers 120 on the protected network 100 can be provided to allow the user to select the physical computer(s) 120 required for maintenance purposes. Once the specific physical computer 120 is selected, a second virtual machine 350 is loaded on the virtual machine 250, in the same manner as described above with respect to FIG. 3. The second virtual machine 350 emulates (e.g., exactly emulates) one of the physical computers 120, particularly the required physical computer 120 for maintenance. The second virtual machine 350 is then placed in a secure test bubble 400 to allow the administrator to test the patches/updates, which can be stored on a USB flash drive. The patches/updates can be in the native format(s) (i.e. readable by the OS) of the target physical computer(s) 120.

A full antivirus, antimalware, and windows log files check can be performed on the patches/updates prior to their installation on the specific physical computer 120. After the patch/update files are tested, they are placed in a designated temporary folder on the first virtual machine 250. Next, the second virtual machine 350 and secure test bubble 400 are demolished and the connection between virtual switch 235 and physical switch 230 is re-established. After the connection between virtual switch 235 and physical switch 230 is re-established, the tested patch/update files are copied to a designated shared folder on virtual server 215. Those files are then copied from the designated shared folder on virtual server 215 to a corresponding designated shared folder on the test network physical servers 210, which is synchronized at an adjustable designated pace, such as at a later time (e.g. during off hours) when traffic is lesser than current time, with a specified shared folder on the protected network physical servers 110. The shared folder on the protected network physical server can function as a library of updates and patches that are tested and labeled as safe to be used by system administrators at any later time and as needed.

In another example, the secure service on virtual machine 250 is used as a secure download service that allows an authorized user to download files to a USB flash drive or other external storage device from a specified shared folder on the test network 200 that is synchronized with a corresponding shared folder on the protected network 100.

In an embodiment, the secure download service can be launched from the web browser running on the first virtual machine 250. The web browser can prompt the user to specify which physical computer 120 in the protected network 100 to download files from, after which the web browser (e.g., GUI) will permit the launching of the secure download service. When the secure download service is launched, a second virtual machine 350 is loaded on the virtual machine 250, in the same manner as described above with respect to FIG. 3. The second virtual machine 350 provides the user with read-only access to a shared folder that is a local copy of a network-accessible folder on the test network 200 that is synchronized with a corresponding network-accessible folder on the protected network 100.

The second virtual machine 350 is then placed in a secure test bubble 400 to allow the user to access the shared folder using the second virtual machine 350 in a secure and isolated environment away from the protected network 100. The USB port on the physical computer 220 is only logically connected to the second virtual machine 350 (e.g., via USB over Ethernet technology). It is not logically connected to the physical computer 220 or any software running thereon. After the files are copied to the USB drive, the secure session is terminated (e.g., following user action) and the first and second virtual machines 250, 350 are destroyed.

In another example, the secure service on virtual machine 250 is used for crisis management, for example in case of a security issue in the protected network 100. In crisis management mode, the user can load a second virtual machine 350 that corresponds to any of the physical computers 120 on the protected network 100. The second virtual machine 350 emulates (e.g., exactly emulates) a desired physical computer 120. When loaded, the second virtual machine 350 has access to a shared folder on the test network 200 that includes all the files needed to run standard, normal tasks, and all output files of the daily working routine until the capabilities/functionality of the protected network 100 are restored. The shared folder on the test network 200 is synchronized with a corresponding shared folder on the protected network 100 for the specific physical computer 120 selected. Any modifications to the files in the shared folder on the test network 200 can be replicated to the corresponding shared folder on the protected network 100, such that the modifications are available on the corresponding physical computer 120 on the protected network 100. In some embodiments, the second virtual machine 350 can be run in a bubble 400 to isolate the second virtual machine 350 from any security issues in the protected network 100. As many second virtual machines 350 as needed can be loaded to partially or completely replicate in the test network 200 the functionality and/or tasks of any physical computers 120 in the protected network 100 which are not available due to the security issue. Thus as many of the physical computers 120 as required can be replicated in the test network 220 using corresponding second virtual machines 350 until the crisis/emergency is over.

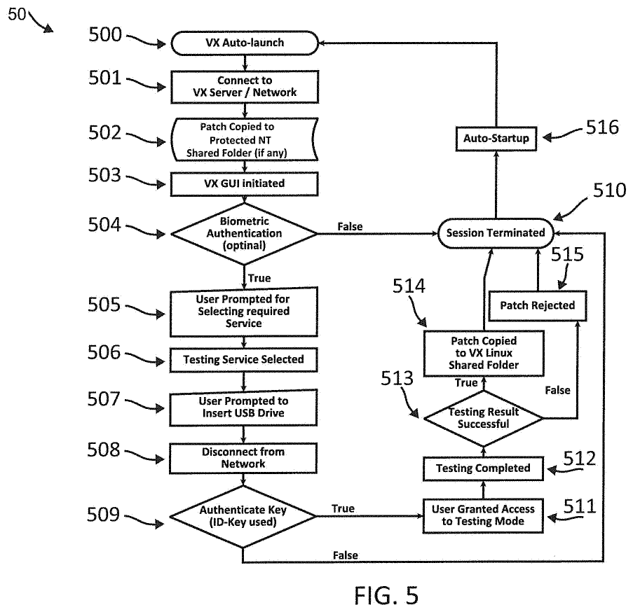

FIG. 5 is a flow chart of a method for secure installation of operating system or application changes and updates (or new applications) to physical computers on a protected network using files from an external media, according to an embodiment.

In step 500, the first virtual machine 250 is automatically launched when the corresponding physical computer 220 is turned on. In step 501, the first virtual machine 250 and the corresponding physical computer 220 are connected to the virtual server 215 and to the physical server(s) 210, respectively (e.g., via the virtual switch 235 and physical switch 230, respectively). In step 502, previous session patches (e.g., previously-tested files such as operating system updates, antivirus updates, software updates, etc.) that have been previously tested on the test network 200 are copied to the shared folder on the test network 200 in the background while the GUI on the web browser running on the first virtual machine 250 is initiated in step 503. In optional step 504, the user is authenticated such as through biometric authentication (e.g., fingerprint scan, retinal scan, etc.).

In step 505, the software running on the first virtual machine 250 prompts the user to select a secure service, such as (1) a secure testing platform for upload purposes, (2) a secure maintenance platform, (3) a secure download service, or (4) crisis management. In step 506, the user selects (1) secure testing platform for upload purposes. The user also selects a target physical computer 120 on the protected network 100 on which to test the files, which is then loaded as the second virtual machine 350. In step 507, the software running on the first virtual machine 250 prompts the user to insert a USB flash drive into a physical USB port on the physical computer 220 on which the first and second virtual machines 250, 350 are running, that includes the files for secure testing. A virtual USB port is created using ‘USB over Ethernet’ technology that creates only a logical connection with the virtual machines 250, 350 and does not create a logical connection with the physical computer 220. In step 508, when the USB flash drive is inserted into the USB port on the physical computer 220 on which the first and second virtual machines 250, 350 are running, the first and second virtual machines 250, 350 are automatically disconnected from all other physical and virtual computers and all physical and virtual servers to form the secure test bubble 400. The first and second virtual machines 230, 350 are on the same virtual network inside the secure test bubble 400 and can access the files to be tested on the USB flash drive.

In optional step 509, the user is required to provide a secondary authentication, such as an ID key or other authentication key, to be granted administrative rights for testing the contents of the USB flash drive. If the user does not provide the secondary authentication, the secure testing session is terminated and the first and second virtual machines 250, 350 and the virtual switch 235 (e.g., the secure test bubble 400) are demolished (e.g., deleted) in step 510. If the user provides the secondary authentication in step 509, the user is granted access to the secure testing platform for upload purposes in step 511.

In step 512, the user performs and completes the secure testing of the files stored on the USB flash drive. The secure testing can include installing the files on the second virtual machine 350, which is in the secure test bubble 400 isolated from the protected network 100 and the test network 200. The installed files can include an update to an application, a new application, an update to the operating system, and/or data files. In some embodiments, the secure testing can include running an antivirus and/or antimalware program on the files stored on the USB flash drive and/or on the installed files on the second virtual machine 350.

In step 513, it is determined whether the secure testing in step 512 is successful. If so, in step 514 the files tested in step 512 are copied to a designated temporary folder on the first virtual machine 250. Next, the second virtual machine 350 and secure test bubble 400 are demolished and the connection between virtual switch 235 and physical switch 230 is re-established. After the connection between virtual switch 235 and physical switch 230 is re-established, the tested files are copied from the designated folder on the first virtual machine 250 to a designated shared folder on virtual server 215. Those file are then copied from the designated shared folder on virtual server 215 to a corresponding designated shared folder on the test network physical servers 210, which is synchronized at an adjustable designated pace with a specified shared folder on the protected network physical servers 110 which can be used to transfer the files to the target physical computer(s) 120. After the tested files are copied from the designated temporary folder on the first virtual machine 250 to the designated shared folder on virtual server 215, the first virtual machine 250 is demolished (e.g., deleted). The files can be synchronized with the specified shared folder on the protected network physical servers 110 immediately or they can be synchronized at a later time (e.g., during off hours) when traffic is lesser than the current time. The shared folder on the protected network physical server 110 is then used to transfer the files to the target physical computer(s) 120. The shared folder on the protected network physical server can function as a library of updates and patches that have been tested and labeled as safe to be used by system administrators at any later time and as needed. The files are preferably not transferred automatically.

If the secure testing in step 512 was not successful, the files (e.g., patch) is rejected in step 515. Following steps 514 and 515, the secure testing session is terminated and the second virtual machine 350 is demolished (e.g., deleted) in step 510. Terminating the secure testing session in step 510 can include deleting the files installed during testing in step 512 and deleting the files stored on the USB flash drive. In some embodiments, deleting the files stored on the USB flash drive includes formatting the USB flash drive. Terminating the secure testing session in step 510 also include deleting the specific second virtual machine 350 used for the secure testing. That second virtual machine 350 can be re-created such as by re-calling the corresponding image of physical computer 120 in the protected network 100 from the Protected Virtual Machines Pool, as described above. Terminating the secure testing session can also include deleting virtual switch 235 and the logical USB over Ethernet port on the virtual machines 250, 350. After step 510, the first virtual machine 250 is automatically re-launched in steps 516 and 500. For example, in step 516 the physical computer(s) 220 are turned on or re-started. In step 500, the first virtual machine 250 and its default web browser (e.g., GUI) are loaded and running.

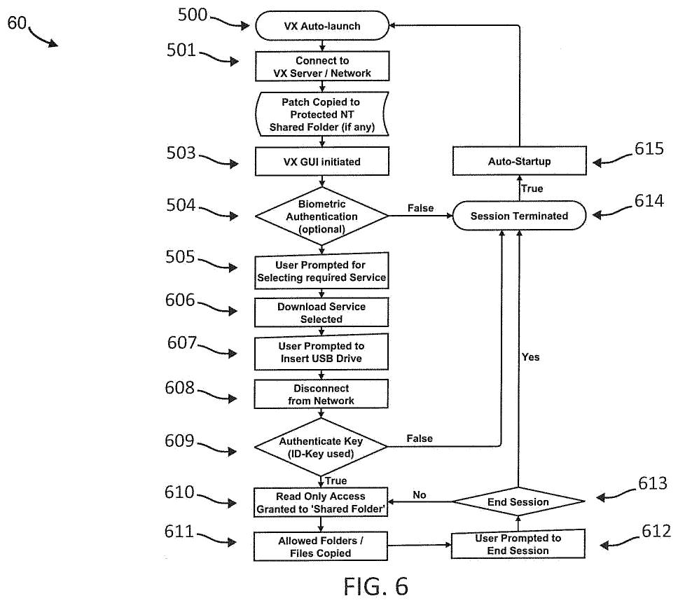

FIG. 6 is a flow chart of a method for downloading files stored on a network-accessible folder to an external movable media device (e.g., a USB flash drive) while securing the protected network according to an embodiment. Steps 500-505 are the same as in flow chart 50. Following step 505 where the software running on the first virtual machine 250 prompts the user to select the secure test service, the user selects a secure download service in step 606. This prompts the first virtual machine 250 to launch a second virtual machine 350 that includes a shared folder, as discussed below. The user is not provided access to the shared folder until step 610.

In step 607, the software running on the first virtual machine 250 prompts the user to insert a USB flash drive into a physical USB port on the physical computer 220 on which the first and second virtual machines 250, 350 are running. As discussed above, the physical USB port is configured as a virtual USB port for the first and second virtual machines 250, 350. There is no logical connection between the physical or virtual USB port and the physical computer 220 or any software running thereon.

In step 608, when the USB flash drive is inserted into the USB port on the physical computer 220 on which the first and second virtual machines 250, 350 are running, the first and second virtual machines 250, 350 are automatically disconnected from all other physical and virtual computers and all physical and virtual servers to form the secure test bubble 400. The first and second virtual machines 250, 350 are in virtual network connection via the virtual switch 235.

In optional step 609, the user is required to provide a secondary authentication, such as an ID key or other authentication key, to be granted administrative rights for downloading the required files from the shared folder on the virtual test server 215 to the USB flash drive. If the user does not provide the secondary authentication, the secure testing session is terminated and the second virtual machine 350 is deleted in step 614. Terminating the secure testing session also includes deleting (e.g., demolishing) the first virtual machine 250, the virtual switch 235, the logical USB over Ethernet port for the first the second virtual machines 250, 350, and the secure test bubble 400. If the user provides the secondary authentication in step 609, the user is granted access to the secure download service including read-only access to a shared folder in step 610. The shared folder is a local copy on virtual machine 350 of a network-accessible folder on the test network 200 that is synchronized with a corresponding network-accessible folder on the protected network 100. This local copy of the shared folder on the second virtual machine 350, is provided in step 610 so that the shared folder can be accessed within the secure test bubble 400. In some embodiments, the files available on the shared folder vary based on the user's authentication/access level in step 609.

In step 611, the user copies any relevant files and/or folders (e.g., downloadable files) from the local copy of the shared folder now available on the second virtual machine 350 to the USB drive inserted to virtual machine 350. After the download is complete, the user is prompted (e.g., via the first virtual machine 250) in step 612 to end the secure testing session

If the user chooses to end the secure testing session in step 613, the secure testing session is terminated and the second virtual machine 350 is deleted, including the files installed/copied during testing in step 611, in step 614. Terminating the secure testing session also includes deleting (e.g., demolishing) the first virtual machine 250, the virtual switch 235, the logical USB over Ethernet port for the first and the second virtual machines 250, 350, and the secure test bubble 400. and deleting the files stored on the local copy of the shared folder. That second virtual machine 350 can be re-created such as by copying relevant shared folder of any physical computer 120 on protected network 100 to a standard OS virtual machine. In this case, the second virtual machine 350 does not need to identically match a specific physical computer 120 as this process is intended to securely download files from the relevant shared folder. After step 614, the first virtual machine 250 is automatically re-launched in steps 615 and 500. For example, in step 615 the physical computer(s) 220 are turned on or re-started. In step 500, the first virtual machine 250 and its default web browser (e.g., GUI) are loaded and running.

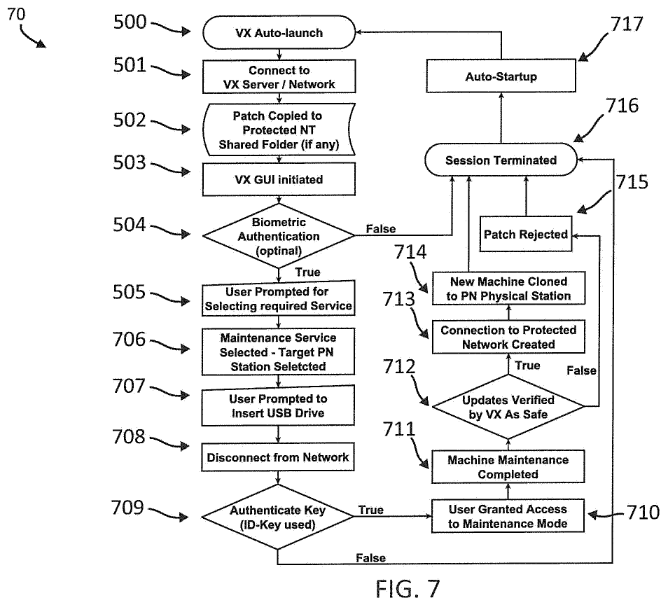

FIG. 7 is a flow chart 70 of a method for secure maintenance of a computer in a protected network according to an embodiment. Steps 500-505 are the same as in flow chart 50. Following step 505 where the GUI (e.g., web browser) on the first virtual machine 250 prompts the user to select a secure test service, the user selects (2) the secure maintenance platform in step 706. In step 707, the GUI (e.g., web browser) on the first virtual machine 250 prompts the user to insert a USB flash drive into a USB port on the physical computer 220 on which the first and second virtual machines 250, 350 are running. The USB port is only logically connected to the second virtual machine 350, as discussed above. In step 708, when the USB flash drive is inserted into the USB port on the physical computer 220 on which the first and second virtual machines 250, 350 are running, the first and second virtual machines 250, 350 are automatically disconnected from all other physical and virtual computers and all physical and virtual servers to form the secure test bubble 400.

In optional step 709, the user is required to provide a secondary authentication, such as an ID key or other authentication key, to be granted administrative rights for using the contents of the USB flash drive through the maintenance process. If the user does not provide the secondary authentication, the secure maintenance session is terminated (e.g., demolishing virtual machines 350, 250, virtual switch 235, the logical USB over Ethernet port, and the secure test bubble 400), in step 716. If the user provides the secondary authentication in step 709, the user is granted access to the secure maintenance platform in step 710.

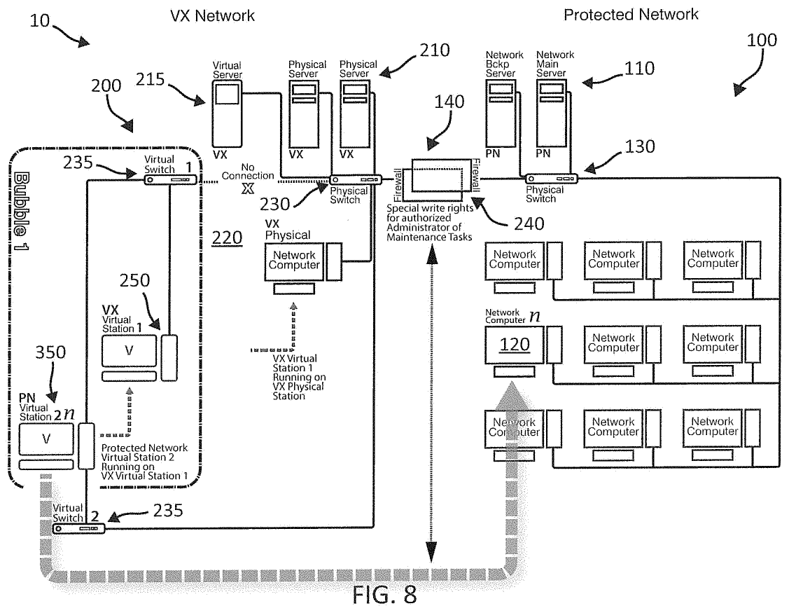

The secure maintenance platform provides the user with the ability to select any specific physical computer 120 on the protected network 100 for performing maintenance. Once a target physical computer 120 is selected, a second virtual machine 350 is loaded that is identical to (e.g., that emulates) the specific physical computer 120 that was selected, as illustrated in FIG. 8. The user can then perform any maintenance tasks on the second virtual machine 350 corresponding to the selected physical computer 120, such as updating the operating system, updating one or more applications (e.g., an antivirus application, an antimalware application, and/or another application), installing a patch, installing a new application, and/or installing other files. The software installed during secure maintenance can be tested prior to installation using the secure testing mode described in flow chart 50. The files for performing the maintenance can be from the USB flash drive and/or a local copy of a shared folder on the first virtual machine 250 that is synchronized with a specified shared folder ‘library’ for such.

After the secure maintenance is completed in step 711 (e.g., as indicated by user input), the update is verified in step 712. Verification of the update can include running a full antivirus scan of the specific virtual machine 350, running a full antimalware scan of the specific virtual machine 350, and/or running a full operating system log files check (e.g., Windows® log file check). If the maintenance update is verified to be safe, a VMDK version of the modified second virtual machine after maintenance, is sent to a virtual machine 250 shared folder, to be synchronized with a dedicated shared folder (e.g., VMDK pool of protected network machines) on VX network servers 215, 210. This modified second virtual machine image can be (1) cloned immediately to the target physical computer 120 (via protected network physical server 110) or (2) scheduled to be cloned at a later time (e.g., when the target physical computer 120 is not being used). The modified second virtual machine image includes the changes made during maintenance to the operating system, applications and/or other files of the target physical computer.

In step 714, the updated image of the specific second virtual machine 350 (e.g., originally emulating protected network physical computer 120, updated as a result of the secure maintenance as completed in step 711) is copied to a designated folder on the first virtual machine 250, in a format that is readable by the software responsible for cloning (e.g. VMDK/ISO). After the image is copied/cloned in step 714, the secure maintenance platform session is terminated and the second virtual machine 350 is closed (e.g., deleted or demolished) in step 716. The updated second virtual machine image is then copied from the designated folder on the first virtual machine 250 to a designated shared folder on the virtual server 215, which is synchronized with a designated shared folder on the protected network physical server 110.

Terminating the secure maintenance platform session in step 716 can include deleting the updated image of the second virtual machine 350, the first and second virtual machines 250, 350, the virtual switch 235, the logical USB over Ethernet port, and the secure test bubble 400. A new second virtual machine 350 can be re-created as/when needed (e.g., by the user selecting a new service through GUI) such as by re-calling the corresponding image of physical computer 120 in the protected network 100 from Protected Virtual Machines Pool, as described above.

Returning to step 712, if the maintenance update is not verified to be safe, then the maintenance update is rejected in step 715. After the maintenance update is rejected, the maintenance platform session is terminated in step 716. In addition to the above, terminating the maintenance platform session in step 716 can include deleting the maintenance update (e.g., demolishing the second virtual machine 350 itself where the maintenance process was implemented).

After step 716, the first virtual machine 250 is automatically re-launched in steps 717 and 500.

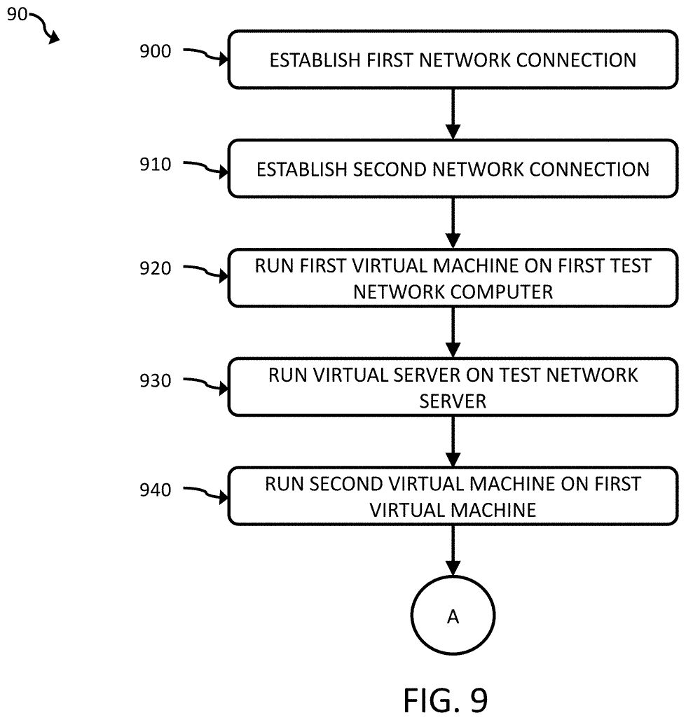

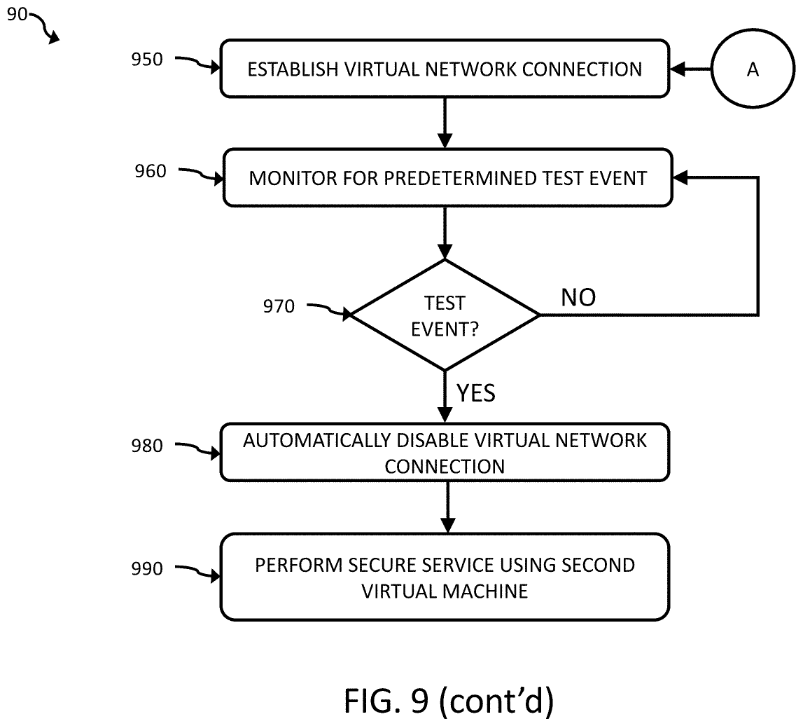

FIG. 9 is a flow chart 90 of a method for securely testing changes to a protected network computer according to an embodiment. In step 900, a first network connection is established between one or more test network servers (e.g., test network server(s) 210) and a protected network (e.g., protected network 100). The first network connection can be established via one or more physical switches (e.g., switches 130, 230) and/or one or more firewalls (e.g., firewalls 140, 240). The protected network includes one or more protected network servers (e.g., protected network server(s) 110) and a plurality of protected network computers (e.g., physical computers 120) that are in network communication with each other by one or more physical switch(es), such as switch(es) 130. In step 910, a second network connection is established between the test network server and a plurality of test network computers (e.g., physical computers 220). The second network connection can be established by one or more physical switch(es), such as switch(es) 230.

In step 920, a first virtual machine (e.g., first virtual machine 250) is run on a first test network computer (e.g., one of the physical computers 220). In step 930, a virtual server (e.g., virtual server 215) is run on the test network server. The virtual server is configured (e.g., with software) to convert each protected network computer into second virtual machine files (e.g., virtual machine disk VMDK format) that are readable by adequate software installed on the first virtual machine (e.g., first virtual machine 250). In step 940, a second virtual machine (e.g., second virtual machine 350) is run on the first virtual machine using files stored on test network virtual servers (e.g., 215) to form a pool of identical virtual images of protected network computers (e.g., 120). These files are in a suitable format (e.g. VMDK) that are readable by virtualization software installed on the first virtual machine (e.g., 250). A GUI on the first virtual machine (e.g., VX GUI, the default welcome screen on virtual machine 250) prompts the user for (1) selecting the type of required service (e.g. testing platform for upload purposes, maintenance platform, download service, or crisis management) and (2) selecting the required protected network computer to perform testing on (e.g., a specific physical computer 120).

In step 950 (via placeholder A), a virtual network connection is established between (a) the first virtual machine and the second virtual machine and (b) the virtual server. The virtual network connection can be established by one or more virtual switches (e.g., virtual switch(es) 235). In step 960, the test network computer and/or the first virtual machine are monitored for a predetermined test event. The monitoring can be performed by the first virtual machine and/or the first test network computer. The test event can include the insertion of an external memory device (e.g., an external hard drive, a USB flash memory device) into a port of the first test network computer, a predetermined user input (e.g., via a graphical user interface), a predetermined user command, or other predetermined event or action. If the predetermined test event has not occurred in step 970, the flow chart 70 loops back to step 960 to continue monitoring until a predetermined test event is detected.

After a predetermined test event has been detected, the flow chart 90 proceeds to step 980 where the virtual network connection is automatically disabled (e.g., to form secure test bubble 400) to isolate the first and second virtual machines from the virtual server (e.g., virtual server 215), the test network (e.g., test network 200), and the protected network (e.g., protected network 100). After the virtual network connection is disabled, in step 990 the second virtual machine is used to perform a secure service using the second virtual machine. The secure service can include (1) testing platform for upload purposes, (2) maintenance platform, (3) download service, and (4) crisis management. In one example, the secure service can be used to emulate changes to the first protected network computer while the first and second virtual machines are isolated from the virtual server to securely test the changes to the first protected network computer in a secure test bubble. In some embodiments, the changes can be verified, such as by using antivirus and/or antimalware software on the second virtual machine and/or windows diagnostic tools, prior/and after securely testing the changes on the second virtual machine. The testing results of the updates/patches are complete only after evaluating the virtualized operating system (e.g., Windows® 10) response to such updates.

When all previous results of antivirus/antimalware and operating system diagnostic tools evaluate as positive, then the process can be deemed as successful, and patch/update can be evaluated as safe to be uploaded to a designated shared folder for future use by protected network administrators. For example, the patch/update files can be saved on a designated shared folder on the first virtual machine (e.g., first virtual machine 250) which synchronizes automatically with a shared folder on the virtual test server (e.g., virtual test server 215). The shared folder on the virtual test server synchronizes automatically with a shared folder on the physical test server (e.g., test server 210), which synchronizes automatically with a shared folder on protected network servers 110.

Alternatively, when the chosen service is ‘maintenance’, the user tests all required files (e.g., patches, updates . . . etc.), after passing the above-mentioned testing procedures and being identified as safe, the whole second virtual machine resembling the chosen protected network physical computer for testing (e.g. 120) plus required maintenance tasks now (120a), will be saved as an image (e.g., VMDK/ISO) on a designated shared folder on virtual machine 250. This shared folder synchronizes automatically with a designated shared folder on test network servers 215, 210, as discussed above. This modified virtual machine 120 (e.g., 120a) image can be (1) cloned immediately to the original physical computer 120 or (2) scheduled to be cloned at a later time (e.g., at a time when the physical computer 120 is not being used).

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in field programmable gate arrays (FPGAs) or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A system comprising:
a protected network comprising:
a protected network server having a physical microprocessor; and
a plurality of protected network computers in network communication with the protected network server, each protected network computer having a physical microprocessor;
a test network in network communication with the protected network, the test network comprising:
a test network server having a physical microprocessor; and
a test network computer having a physical microprocessor, the test network computer in network communication with the test network server,
wherein:
the test network computer runs a first virtual machine that monitors the test network computer and/or the first virtual machine for a predetermined test event,
the first virtual machine runs a second virtual machine that emulates a first protected network computer,
the test network server runs a virtual server that is in virtual network communication with the first and second virtual machines, and
when the predetermined test event occurs:
the first and second virtual machines are automatically disconnected from the virtual server, the test network server, and the protected network to isolate the first and second virtual machines in a secure test bubble.

2. The system of claim 1, wherein the predetermined test event comprises a connection of an external memory device to the test network computer.

3. The system of claim 2, wherein the external memory device comprises a USB flash drive.

4. The system of claim 2, wherein the external memory device includes one or more files stored thereon, the one or more files corresponding to changes to the first protected network computer.

5. The system of claim 1, wherein the predetermined test event comprises a user input on the test network computer and/or on the first virtual machine.

6. The system of claim 1, wherein the first virtual machine is configured to automatically restart in response to a signal that indicates that a user has completed a secure service on the second virtual machine, thereby deleting both the first and second virtual machines.

7. The system of claim 1, wherein the virtual server is configured to convert each protected network computer into second virtual machine files that are readable by the first virtual machine to run the second virtual machine.

8. The system of claim 7, wherein the virtual server is configured to monitor for changes to each protected network computer and to update the second virtual machine files accordingly.

9. The system of claim 1, wherein the second virtual machine is configured to have access to a local copy of a network-accessible shared folder, the local copy comprising one or more files that correspond to downloadable files for the first protected network computer.

10. A method comprising:
establishing a first network connection between a test network server and a protected network, the protected network including a protected network server and a plurality of protected network computers, the protected network server and the protected network computers in network communication with each other;
establishing a second network connection between the test network server and a plurality of test network computers;
running a first virtual machine on a first test network computer;
running a virtual server on the test network server, the virtual server configured to convert each protected network computer into second virtual machine files, the second virtual machine files readable by the first virtual machine;
running a second virtual machine on the first virtual machine using the second virtual machine files for a specific protected network computer;
establishing a virtual network connection between (a) the first virtual machine and the second virtual machine and (b) and the virtual server;
monitoring, with the first virtual machine, the test network computer and/or the first virtual machine for a predetermined test event; and
when the predetermined test event occurs:
automatically disabling the virtual network connection to isolate the first and second virtual machines from the virtual server, the test network server, and the protected network in a secure test bubble, and
performing a secure service with the second virtual machine while the first and second virtual machines are in the secure test bubble.

11. The method of claim 10, wherein the predetermined test event comprises connecting an external memory device to the first test network computer.

12. The method of claim 11, wherein the external memory device comprises a USB flash drive.

13. The method of claim 11, wherein the external memory device includes one or more files stored thereon, the one or more files corresponding to the changes to the first protected network computer.

14. The method of claim 10, wherein the predetermined test event comprises a user input on the first test network computer and/or on the first virtual machine.

15. The method of claim 10, further comprising automatically deleting the first and second virtual machines in response to a signal that indicates that a user has completed the secure service in the secure test bubble.

16. The method of claim 10, wherein the virtual server is configured to monitor for changes to each protected network computer and to update the second virtual machine files accordingly.

17. The method of claim 10, wherein the second virtual machine is configured to have access to a local copy of a network-accessible shared folder, the local copy comprising one or more files that correspond to downloadable file(s) for the first protected network computer.

18. The method of claim 10, further comprising:
using the first virtual machine to determine whether a software change is safe to install on the first protected network computer; and
when the first virtual machine determines that the software change is safe to install, the method further includes:
saving files corresponding to the software changes to a shared folder on the test network server;
synchronizing the shared folder on the test network server with a shared folder on the protected network server to copy the files from the test network server to the protected network server; and
copying the files from the shared folder on the protected network server to the first protected network computer.

19. The method of claim 18, further comprising running an antivirus application on the first virtual machine to determine whether the software change includes a virus or a malware.

20. The method of claim 10, further comprising:
using the first virtual machine to determine whether a software change is safe to install on the first protected network computer; and
when the first virtual machine determines that the software change is safe to install, the method further includes:
saving a modified image of the first protected network computer to a shared folder on the test network server, wherein the software change comprises a maintenance activity for the first protected network computer;
saving the modified image from the shared folder on the test network server to a shared folder on the protected network server; and
cloning the modified image to the first protected network computer from the shared folder on the protected network server at a time selected with the least traffic on the protected network based on historical traffic data.

21. The method of claim 10, wherein the secure service comprises downloading a file from the second virtual machine to an external memory device.

22. The method of claim 10, wherein the second virtual machine files comprises a virtual machine disk VMDK format readable by the first virtual machine
